(19) United States
(12) Patent Application Publication
(10) Pub. No.: US 2003/0058501 A1
(43) Pub. Date: Mar. 27, 2003

(54) Wireless communication system comprising a host and a guest, and method associated herewith

(76) Inventors: Pieter Dingenis Griep, Leuven (BE); Marc Emiel Celine Lambrechts, Kessel-Lo (BE)

Correspondence Address: U.S. Philips Corporation, 580 White Plains Road, Tarrytown, NY, 10591, US

(21) Appl. No.: 10/247,197

(22) Filed: Sep. 19, 2002

(30) Foreign Application Priority Data
Sep. 24, 2001 (EP) 01203612.5

(51) Int. Cl. H04B 10/10

(52) U.S. Cl. 359/142; 359/172

(57) ABSTRACT

A wireless communication system comprises a guest (2) with a transmitter (3, 23) for transmitting infrared signals and a host (2) with a host_receiver (4, 24) for receiving an infrared signal (5, 25), both the guest and the host having an internal RS-232 port (28, 32). The guest comprises a data generator (26) for generating data, a modulator (30) for modulating said data and transferring said modulated data to the guest transmitter (23). The host comprises a demodulator (31) for demodulating the IR signal received by the host receiver. The guest (2, 21) comprises a coding function (27) to code data generated by the data generator in standard RS-232 format to reduce the maximum number of consecutive spaces in the signal sent. The demodulator of the host is coupled to the host receiver and the internal RS-232 port of the host to demodulate the modulated IR signals and to a main processor (34) coupled to the host internal RS-232 port. A decoding function (33) in the main processor of the host (2) does the decoding by means of a lookup table. An important advantage of the invention is that the need for an additional microprocessor is removed.

### DESCRIPTION OF PRIOR ART

The invention relates to a wireless communication system comprising at least one guest having a guest_transmitter for transmitting infrared signals and a host having a host_receiver for receiving an infrared signal transmitted by the guest, both the guest and the host having an internal RS-232 port, the guest comprising a data generator for generating data and a modulator for modulating said data and transferring said modulated data to the guest transmitter, the host comprising a demodulator for demodulating the IR signal received by the host receiver and a data interpreter for interpreting the received signals.

Such wireless communication systems are known. In such systems a guest, usually a mobile station (e.g. a remote control) communicates with a host (e.g. set top box). An example of such a system is a Sejin WEB-TV system. The data in the known systems are transported in the NRZ (non-return to zero) format. A wireless RS-232 data link is established by connecting the transmitter and receiver directly to a serial RS-232 port of the host.

The information as generated inside the guest and handled inside the host in usually in the form of NRZ (Non return to Zero) signals, meaning a sequence of ones and zeros. NRZ data can be seen as a sequence of rectangular pulses. In the known devices all data are in accordance with the RS-232 standard data format. In the standard RS-232 data format the signal is composed of sequences of 8 data bits, 1 start bit and 1 or 2 stop bits, thus each character comprising 10 or 11 bits in all, each bit being either a zero (also called space) or a 1 (also called mark).

Signals in the standard RS-232 data format for establishing a direct link between host and guest through a wireless transmission channel modulation can be (de)modulated to transfer said data from the guest to the host. However, one or more of the following problems will arise when transmitting and receiving this modulated data:

Noise and interference susceptibility

Data bit errors

Sensitivity decrease due to AGC tuning on carrier based IR receivers

High power consumption in infrared transmitter stage

### SUMMARY OF THE INVENTION

It is an object of the invention to provide a wireless communication system in which one or more of the above problems are solved and/or reduced, while, however, restricting the need for an additional microprocessor unit especially in the host.

To this end, a first embodiment of the wireless communication system in accordance with the invention is characterized in that the guest comprises a coding function to code data generated by the data generator in standard RS-232 to a code in which the number of data bits per character is increased while the maximum number of consecutive spaces is decreased, send the coded data to the internal guest RS 232-port, the modulator being coupled to said guest RS-232 port and the guest transmitter, the demodulator coupled to the host receiver and the internal RS-232 port of the host to demodulate the modulated IR signals and a main processor coupled to the host internal RS-232 port.

A second embodiment of the wireless communication system in accordance with the invention is characterized in that the guest comprises a coding function to code data generated by the data generator in standard RS-232 to a code in which the number of data bits per character is increased while the maximum number of consecutive marks is decreased, send the coded data to the internal guest RS 232-port, the modulator being coupled to said guest RS-232 port and the guest transmitter, the demodulator coupled to the host receiver and the internal RS-232 port of the host to demodulate the modulated IR signals and a main processor coupled to the host internal RS-232 port, wherein the guest transmitter comprises an inverter for inverting marks to spaces and vice versa.

Converting the standard RS-232 code to a code having an increased number of bits, and a decreased number of maximum consecutive spaces (in the first embodiment) enables at least some of the above mentioned problems to be reduced. In the second embodiment the maximum number of consecutive marks is reduced, but due to the inverter, which inverts spaces to marks and vice versa, this embodiment is equivalent to the first in the aspect that in the signal sent the maximum number of consecutive spaces is reduced. More in particular (as will be explained below) due to the reduction of the maximum number of consecutive spaces in the signal transmitted between the transmitter and receiver bandwidth reduction is possible, reducing the noise and interference susceptibility, and the ratio between the maximum and minimum pulse duration can be reduced, which reduces bit errors when use is made of a data-slicing circuit in the receiver.

In the system according to the invention coding of the data is performed by the coding function, which can be a coder (e.g. a microprocessor or a coding circuit) or a coding software function in the guest, sending the coded data to the internal RS-232 port of the guest, which then transfers them to the IR transmitter which modulates the signals and sends it. The transmitter can, as in the second embodiment comprise an inverter to invert marks to spaces and vice versa. Because it is send through the internal RS-232 port the timing of the bits is as in standard RS-232 format. The coded signals are modulated and sent to the receiver of the host, the received signals are demodulated in the host. The demodulated yet still coded signals can then be send directly to and through the RS-232 UART of the host (because the timing of the bits is as in standard RS-232 format). Such RS-232 UART is a commodity interface of many processors. The signals transferred through the RS-232 UART can then be decoded in a decoding function of the main processor, without the need of a separate micro processing unit. In the known systems use is often made of RS-232 timing independent coding functions requiring an additional microprocessor unit. Coding and decoding schemes which change the timing of the bits from the standard RS-232 format require a separate micro controller in the host in between the receiver/demodulator of the host and the RS-232 UART for decoding the signals and transferring them into signals which can be handled by the RS-232 UART of the main processor. Such additional microprocessor increases considerably the cost of the system. In the systems and method in accordance with the invention decoding is done behind the RS-232 UART of the host which removes the need for an additional microprocessor. Coding and decoding schemes which would not decrease the maximum number of consecutive marks or spaces as in the present invention do not or only to a lesser degree result in a reduction of the mentioned problems.

It is remarked that the increase of the number of bits per character in the coded data decreases per se the maximum speed of transfer of data (gross datarate), when only the sending/receiving part is considered. However, the overall effective maximum data transfer rate (net datarate) is, in comparison to systems in which coding is done which necessitate the use of a separate microprocessor in front of the RS-232 UART, not reduced, but grosso modo comparable or even increased, due to the fact that no separate micro controller is needed. Such a microprocessor inherently considerably slows down the transfer speed of the system seen as a whole.

In a preferred embodiment, the coding circuit codes the data such that the maximum number of consecutive spaces is equal to the minimum number of consecutive spaces or marks. Such coding/decoding schemes offer a very favorable reduction of the above-mentioned problems.

In a further preferred embodiment the coding/decoding is done by means of a coding/decoding table.

These and other aspects of the invention are apparent from and will be elucidated with reference to the embodiments described hereafter.

### SHORT DESCRIPTION OF THE DRAWINGS

In the drawings:

FIG. 1 shows schematically a wireless communication system,

FIG. 2 shows schematically a guest and a host of a wireless communication in accordance with the first embodiment of the invention.

FIG. 3 shows schematically a guest and a host of a wireless communication in accordance with the second embodiment of the invention.

The Figures are not drawn to scale. Generally, identical components are denoted by like reference numerals in the Figures.

### DETAILED DESCRIPTION OF PREFERRED EMBODIMENTS

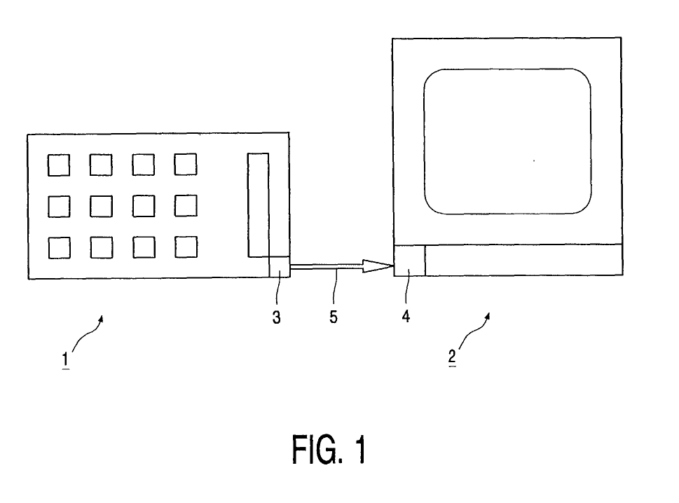

FIG. 1 shows schematically a general case of a wireless communication system comprising at least one host 2 and at least one guest (1). Guests (1) and hosts (2) communicate with each other by transmitting and receiving IR signals (5) (indicated by an arrow) over a wireless medium. The guest comprises a transmitter (3) for transmitting IR signals, the host comprises a receiver (4) for receiving the IR signals. The IR signals are modulated.

Signals in the standard RS-232 data format for establishing a direct link between host and guest through a wireless transmission channel modulation can be (de)modulated to transfer said data from the guest to the host. However, one or more of the following problems will arise when transmitting and receiving this modulated data:

Noise and interference susceptibility due to high bandwidth requirements for NRZ data

NRZ data bit errors due to errors on data slicing with adaptive slice reference

Sensitivity decrease due to AGC tuning on carrier based IR receivers

High power consumption in infrared transmitter stage

The RS-232 standard defines two logic levels:

Logic ‘0’ is called ‘space’ and has a voltage level from 3.3 to 15V

Logic ‘1’ is called ‘mark’ and has a voltage level from −3.3 to −15V

A byte can be seen as a sequence of rectangular pulses, where the minimum duration Tₘᵢₙ of a pulse is represented by the minimum number of consecutive spaces times the standard duration of a bit. This equals one bit-time. The maximum number of consecutive spaces (followed by a mark) represents the maximum pulse duration Tₘₐₓ. This maximum duration Tₘₐₓ equals ten bit-times according to the RS-232 standard (Stop-start bit transition is always Space-Mark).

Modulating and demodulating such signals through a wireless link will mean that, as the wireless link transports pulses with duration times ranging from Tₘᵢₙ to Tₘₐₓ, the demodulated signal requires a bandwidth from 1/Tₘₐₓ to 1/Tₘᵢₙ. This high bandwidth requirement will make the wireless link susceptible to inner-band noise and interference. A reduction of the required bandwidth reduces this problems. In the system in accordance with the invention the maximum number of consecutive spaces is reduced, thus Tₘₐₓ is reduced, and the required bandwidth is reduced. In a preferred embodiment the maximum and minimum number of consecutive spaces is the same, i.e. 1 and the required bandwidth is strongly reduced. This advantage holds for all systems.

When a data slicing circuit is used in the receiver a further advantage emerges. Many receivers use a data-slicing circuit with adaptive slice reference for pulse-shaping the demodulated output signal to proper digital signal levels. The adaptive slice reference is set with a slicing level time constant t_{slice}. The most effective slicing level time constant is a trade-off between three extreme situations:

the maximum number of consecutive spaces followed by a mark,

one space followed by a maximum number of marks,

one space followed by a mark.

In the system in accordance with the invention the extremes are closer to each other, which enables a better trade-off and thereby a reduction of time delays and bit errors.

When AGC tuning is done on carrier-based IR receivers a further advantage emerges.

Many carrier-based IR receivers have an AGC (automatic gain control) function inside. This AGC has a time constant set t_{AGC} to a large value to make the IR receiver insensitive to noise from DC light sources, but sensitive to short-duration pulses. This time constant t_{AGC} must be larger than Tₘₐₓ, otherwise genuine signals are not received. Since Tₘₐₓ is reduced in a system in accordance with the invention t_{AGC} can be reduced, noise can be reduced.

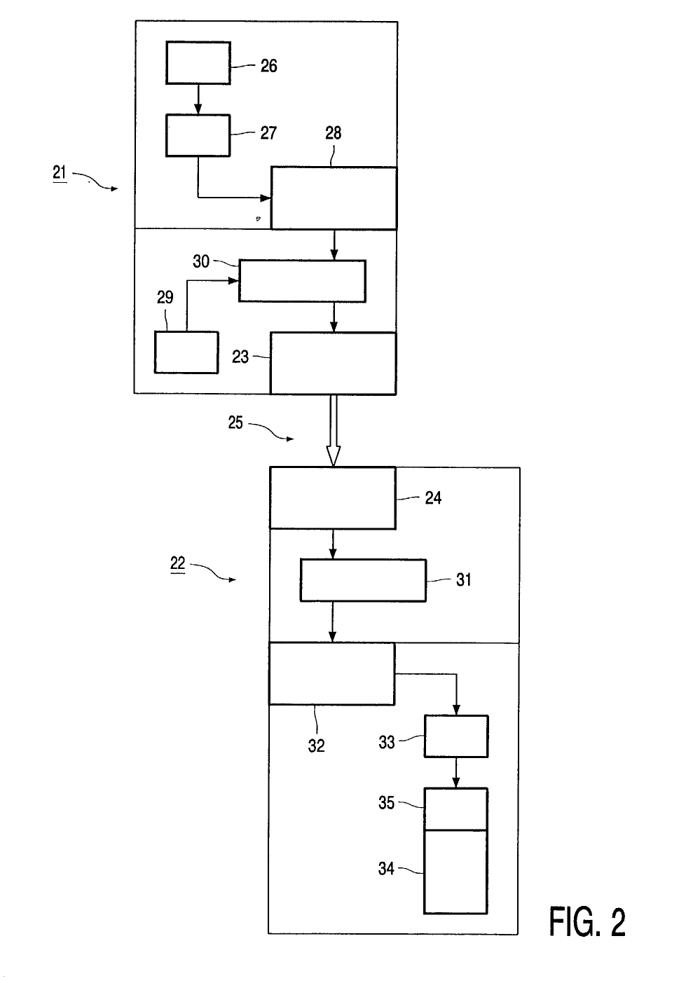

FIG. 2 shows schematically a guest (21) of the wireless communication system of FIG. 1. The guest comprises a transmitter (23), a generator (26) for generating data and a coding software function (27) for coding the data and sending the coded data to an internal RS 232 port (28), the coded signals are modulated in a modulator (30) which is provided with a carrier frequency by carrier frequency generator (29). The coded and modulated signals (25) are transmitted to a host (22), which comprises a receiver (24), which sends the coded and modulated signals to demodulator (31). The receiver comprises in this example an AGC (Automatic gain control) circuit. After demodulation the signals are transferred through the internal RS 232 port (32) after having optionally been pulse-shaped by means of an adaptive slice reference circuit, and decoded in and by the main processor (34) which main processor comprises a decoding function (35). The decoding function could be any piece of hardware or software, such as a circuit or a (part of) a program for decoding the coded data. For decoding use is made of a look-up table in a preferred embodiment. In preferred embodiments the RS 232 port is provided with an RS 232 buffer circuit (33). This provides the additional advantage of higher speed or alternatively and/or partly in common the possibility that the time response of the main processor can be lowered.

A possible coding/decoding scheme is given in the table 1 below in which a sequence of 4 bits of the original signal is coded in 8 bits, where 1 stands for a mark and 0 for a space. Both the coding circuit in the guest and the decoder in the main processor comprise means for converting uncoded data in coded (Manchester bi-phase) data and vice versa in accordance with this table.

TABLE 1

| Original signal | Coded signal | Remarks |
|---|---|---|
| 0000 | 0101 0101 | Coding is done |
| 0001 | 0101 0110 | before sending the |
| 0010 | 0101 1001 | signals through the |
| 0011 | 0101 1010 | internal RS-323 port |
| 0100 | 0110 0101 | of the guest. |
| 0101 | 0110 0110 | Decoding is done |
| 0110 | 0110 1001 | after the internal |
| 0111 | 0110 1010 | RS-323 port of the |
| 1000 | 1001 0101 | main processor of the |
| 1001 | 1001 0110 | host, in the main |
| 1010 | 1001 1001 | processor of the host |
| 1011 | 1001 1010 | |
| 1100 | 1010 0101 | |
| 1101 | 1010 0110 | |
| 1110 | 1010 1001 | |
| 1111 | 1010 1010 | |

It can be seen that whereas the maximum number of consecutive spaces (zeroes) in the original signal is four (4), thus tₘₐₓ is four times the bit time, the maximum number of consecutive spaces in the coded signal is two (2), and thus tₘₐₓ is two times the bit time. It may further be remarked for the example of embodiment given above that for each byte sent (=2 coded signals of 8 bits each) the maximum number of consecutive zeroes is reduced from 8 to 2. The bandwidth of the demodulated signal can be considerably reduced due to the reduction of tₘₐₓ, thus reducing susceptibility to inner band noise and interference. The signals themselves, having been coded before being sent through the internal RS-323 port of the guest, whereafter the signals have been modulated, can be directly sent through the internal RS-323 UART of the main processor of the host after having been received and demodulated with the demodulator. Since Tₘₐₓ is reduced, T_{AGC} can be reduced, improving the signal-to-noise ratio. Since Tₘₐₓ is reduced (as is the ratio Tₘₐₓ/Tₘᵢₙ) errors due to data slicing can be reduced.

A further example of a coding scheme in accordance with the invention is in the table 2 below.

TABLE 2

| Original signal | Coded signal | Remarks |
|---|---|---|
| 0000 | 1111 0101 | Coding is done |
| 0001 | 1110 1011 | before sending the |
| 0010 | 1101 0111 | signals through the |
| 0011 | 1010 1111 | internal RS-323 port |
| 0100 | 0101 1111 | of the guest. |
| 0101 | 1110 1101 | Decoding is done |
| 0110 | 1101 1011 | after the internal |
| 0111 | 1011 0111 | RS-323 port of the |
| 1000 | 0110 1111 | main processor of the |
| 1001 | 1101 1101 | host, in the main |
| 1010 | 1011 1011 | processor of the host |
| 1011 | 0111 0111 | |
| 1100 | 1011 1101 | |
| 1101 | 0111 1011 | |
| 1110 | 0110 1101 | |
| 1111 | 1011 1111 | |

It can be seen that whereas the maximum number of consecutive spaces (zeroes) in the original signal is four (4), thus tₘₐₓ is four times the bit time, the maximum number of consecutive spaces in the coded signal is one (1), and thus tₘₐₓ is one bit time. It is also to be noted that in this scheme the last bit of the eight-bit-coded data is always a mark (a 1). As a consequence, when two 8-bit data are sent, the maximum number of consecutive space remains one. The bandwidth can even be reduced more than in the given first example. An advantage of the coding scheme shown in table 2 over the scheme shown in table 1 is that the average number of zeroes per coded signal is two (2). During transfer of the data a zero requires energy. In the scheme in accordance with table 2 this energy is lower than in the scheme in accordance with table 1, and although the same as for the uncoded data on average, more constant than for the uncoded data. In this scheme the maximum number of consecutive spaces als equals the minimum number of consecutive spaces. The ratio Tₘₐₓ/Tₘᵢₙ is thereby reduced as much as possible.

The tables given above show examples of a coding/decoding scheme usable in a device in accordance with the invention.

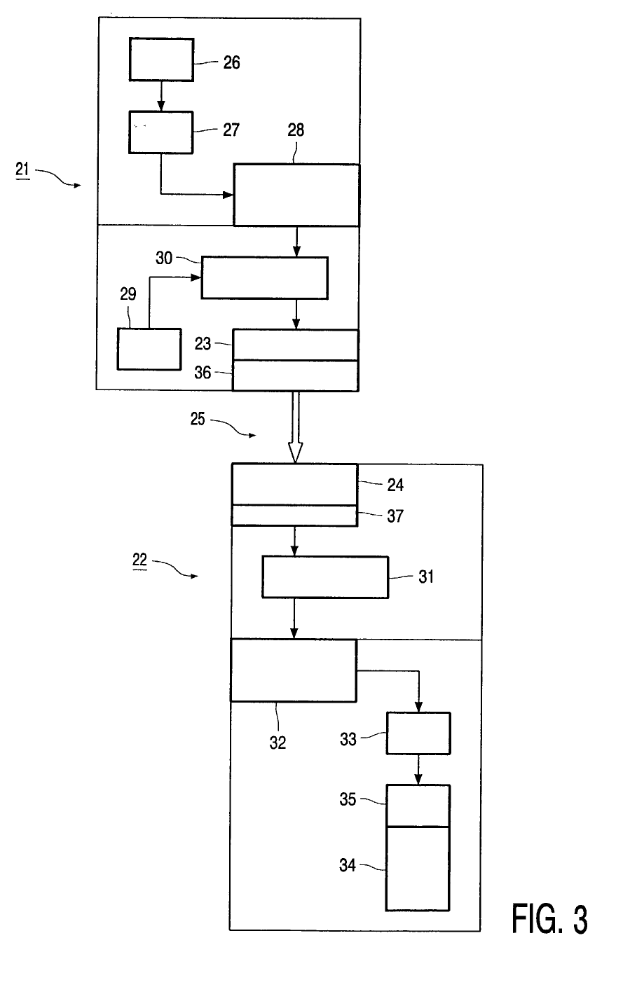

FIG. 3 shows an example of the second embodiment of the invention. In this embodiment the transmitter 23 comprises an inverter to invert marks into spaces and vice versa. Likewise the receiver 24 comprises an inverter 37. In the second embodiment the coding function is such that the maximum number of consecutive marks is reduced. By, for instance, changing in tables 1 and 2 in the coded signals all ones into zeroes and vice versa, two examples of such coding schemes can be obtained. Since the maximum number of consecutives marks in the coded signal is decreased and the coded signal is sent in inverted mode, the maximum number of consecutive spaces in the signal sent is decreased with the advantages mentioned above. Inversion of the signal can be beneficial to reduced power consumption.

As is shown, the receiver comprises an inverter. In embodiments this receiver inverter could be dispensed with if the decoding table in the main processor is a mirror image of the coding table in the guest. On the one hand such a system requires a somewhat more complicated coding/decoding scheme, since the coding/decoding tables are not exactly equal to each other, on the other hand, however, there is no need for an inverter in the receiver, which reduces cost.

It is remarked that table 1 illustrates a coding scheme in which the maximum number of consecutive marks and the maximum number of consecutive spaces are reduced (from 4 to 2) and, in the example of table 1 both to the same amount. Such coding/decoding schemes, in general all coding schemes in which both the maximum number of consecutive marks and spaces are decreased, are therefore applicable in the first as well as the second embodiment, i.e. with or without inversion just prior to transmission between guest and host.

For all coding/decoding schemes shown above, decoding is done behind the RS-232 UART of the host in the main processor, without the need for an additional microprocessor as in known systems. The possibility of not having to use a microprocessor offers great advantages, both in terms of cost as well as in terms of overall net bit transfer rates.

In short the invention may be described as follows:

A wireless communication system comprises a guest (2) with a transmitter (3, 23) for transmitting infrared signals and a host (2) with a host_receiver (4, 24) for receiving an infrared signal (5, 25), both the guest and the host having an internal RS-232 port (28, 32). The guest comprises a data generator (26) for generating data, a modulator (30) for modulating said data and transferring said modulated data to the guest transmitter (23). The host comprises a demodulator (31) for demodulating the IR signal received by the host receiver. The guest (2, 21) comprises a coding circuit (27) to code data generated by the data generator in standard RS-232 format to reduce the maximum number of consecutive spaces in the signal sent. The demodulator of the host is coupled to the host receiver and the internal RS-232 port of the host to demodulate the modulated IR signals and a main processor (34) coupled to the host-internal RS-232 port is used for decoding the data, e.g. preferably by means of a lookup table. Preferably the coding function presides in the host, which neither needs nor has an additional microprocessor for decoding.

1. A wireless communication system comprising at least one guest (1, 21) having a guest_transmitter (3, 23) for transmitting infrared signals and a host (2) having a host_receiver (4, 24) for receiving an infrared signal (5, 25) transmitted by the guest, both the guest and the host having an internal RS-232 port (28, 32), the guest comprising a data generator (26) for generating data and a modulator for modulating (30) said data and transferring said modulated data to the guest transmitter (23), the host comprising a demodulator (31) for demodulating the IR signal received by the host receiver characterized in that the guest (2, 21) comprises a coding function (27) to code data generated by the data generator in standard RS-232 to a code in which the number of data bits per character is increased while the maximum number of consecutive spaces is decreased in comparison with uncoded data and send the coded data to the internal guest RS 232-port, the modulator (30) being coupled to said guest RS-232 port (28) and the guest transmitter (23), the host comprising the demodulator coupled to the host receiver (24) and the internal RS-232 port (32) of the host to demodulate the modulated IR signals and a main processor (34) coupled to the host internal RS-232 port (32), the host comprising a decoding function (35) for decoding the demodulated data received through the internal RS-232 port of the host.

2. A wireless communication system as claimed in claim 1 or 2, characterized in that the coding function codes the data such that the maximum number of consecutive spaces is equal to the minimum number of consecutive spaces.

3. A wireless communication system as claimed in claim 1, characterized in that the coding function codes the data such that the maximum number of consecutive marks is reduced.

4. A wireless communication system comprising at least one guest (1, 21) having a guest_transmitter (3, 23) for transmitting infrared signals and a host (2) having a host_receiver (4, 24) for receiving an infrared signal (5, 25) transmitted by the guest, both the guest and the host having an internal RS-232 port (28, 32), the guest comprising a data generator (26) for generating data and a modulator for modulating (30) said data and transferring said modulated data to the guest transmitter (23), the host comprising a demodulator (31) for demodulating the IR signal received by the host receiver characterized in that the guest (2, 21) comprises a coding function (27) to code data generated by the data generator in standard RS-232 to a code in which the number of data bits per character is increased while the maximum number of consecutive marks is decreased in comparison with uncoded data and send the coded data to the internal guest RS 232-port, the modulator (30) being coupled to said guest RS-232 port (28) and the guest transmitter (23), the guest transmitter comprising an inverter for inverting marks to spaces and vice versa, the host comprising the demodulator coupled to the host receiver (24) and the internal RS-232 port (32) of the host to demodulate the modulated IR signals and a main processor (34) coupled to the host internal RS-232 port (32), the host comprising a decoding function (35) for decoding the demodulated data received through the internal RS-232 port of the host.

5. A wireless communication system as claimed in claim 5, characterized in that the host receiver comprises an inverter for inverting marks to spaces and vice versa.

6. A wireless communication system as claimed in claim 1 or 2, characterized in that the main processor comprises the decoding function (35).

7. A wireless communication system as claimed in claim 6, characterized in that the host does not comprise a microprocessor, separate from the main processor, for decoding.

8. A wireless communication system as claimed in claim 4, characterized in that the coding function codes the data such that the maximum number of consecutive marks is equal to the minimum number of consecutive marks.

9. A wireless communication system as claimed in claim 1 or 4, characterized in that the coding/decoding is done by means of a coding/decoding lookup table.

10. A wireless communication system as claimed in claim 1 or 4, characterized in that the host receiver comprises an adaptive slice reference circuit for pulse-shaping the demodulated output signal.

11. A wireless communication system as claimed in claim 1 or 4, characterized in that the host receiver comprises an AGC circuit.

12. A method of transferring data in a wireless communication system, said system comprising at least one guest (1, 21) having a guest_transmitter (3, 23) for transmitting infrared signals and a host (2) having a host_receiver (4, 24) for receiving an infrared signal (5, 25) transmitted by the guest, both the guest and the host having an internal RS-232 port (28, 32), in which method
data are generated and modulated in the guest and
said modulated data are transferred to the guest transmitter (23),
the modulated data are demodulated in the host,
characterized in that
in the guest (2, 21) the data are coded to a code in which the number of data bits per character is increased while the maximum number of consecutive spaces is decreased in comparison with uncoded data, whereafter
the coded data are sent to the internal guest RS 232-port (28), the coded data are modulated and transmitted, the transmitted data are demodulated prior to being transferred to the internal RS-232 port (32) of the host and whereafter the coded data are decoded in the host, or in that
in the guest (2, 21) the data are coded to a code in which the number of data bits per character is increased while the maximum number of consecutive marks is decreased in comparison with uncoded data, whereafter
the coded data are sent to the internal guest RS 232-port (28), the coded data are modulated, inverted and transmitted, the transmitted data are demodulated prior to being transferred to the internal RS-232 port (32) of the host and whereafter the coded data are decoded in the host.

13. A method of transferring data in a wireless communication system as claimed in claim 12, characterized in that the coded data are decoded in the main processor by a decoding function.
